(19) United States
(12) Patent Application Publication
(10) Pub. No.: US 2025/0342387 A1
(43) Pub. Date: Nov. 6, 2025

(54) COMPUTER-BASED SYSTEMS FOR BINDING AT LEAST ONE UNIQUE SCHEMA-SPECIFIC IDENTIFIER TO A CATEGORY AND METHODS OF USE THEREOF

(71) Applicant: Capital One Services, LLC, McLean, VA (US)

(72) Inventors: Jackson Macomber, Henrico, VA (US); Tara Alemzadeh, Washington, DC (US); Charlie Gene Size, Arlington, VA (US)

(21) Appl. No.: 18/652,563

(22) Filed: May 1, 2024

(51) Int. Cl. G06N 20/00

(52) U.S. Cl. CPC G06N 20/00

(57) ABSTRACT

A method including receiving activity data related to a first activity utilizing an unbound schema-specific identifier; training a machine learning engine based on at least one input to obtain a trained machine learning engine that is trained to identify a category associated with the entity; where the at least one input includes: an entity data feature vector, a historical user activity data feature vector, and/or a historical user schema-specific identifier data feature vector; predicting via the trained machine learning engine, a category associated with the first activity; binding the unbound schema-specific identifier to the category to generate a category bound schema-specific identifier; receiving a request to perform a second activity using the bound schema-specific identifier; determining if a second entity associated with the request to perform the second activity is associated with the category; performing one of: approving or denying the request to perform the second activity.

### TECHNICAL FIELD

The present disclosure generally relates to computer-based systems and methods configured for binding unique schema-specific identifiers. More specifically, the present disclosure relates to computer-based systems and methods for binding unique schema-specific identifiers to specific categories.

### BACKGROUND

Virtual card numbers are a convenient transactional tool. Virtual card numbers (VCNs) are sometimes referred to as virtual credit cards or virtual cards and they may allow a customer to shop without giving merchants the customer's actual credit card or account number.

VCNs may be utilized as substitutes for an actual credit card or account number. VCNs may still be linked to a customer's account, but allow the customer to use a different number to pay. This means a customer's actual account number is less exposed-adding another layer of security.

### SUMMARY

In some embodiments, the present disclosure provides an exemplary technically improved computer-based method that includes at least the following steps of generating, by at least one processor, an unbound schema-specific identifier associated with a user profile of a user; where the user profile is associated with an entity; receiving, by the at least one processor, activity data related to at least one first activity performed by the user utilizing the unbound schema-specific identifier; training, by at least one processor, an entity category determining machine learning engine based on at least one input to obtain a trained entity category determining machine learning engine that is trained to identify at least one category associated with the entity; where the at least one input includes at least one of: at least one entity data feature vector, at least one historical user activity data feature vector associated with the user profile, or at least one historical user schema-specific identifier data feature vector; predicting, by the at least one processor, via the trained entity category determining machine learning engine, at least one predicted category associated with the at least one first activity performed by the user; binding, by the at least one processor, the unbound schema-specific identifier to at least one binding category to generate a category bound schema-specific identifier; where the at least one binding category is based on the at least one predicted category from the trained entity category determining machine learning engine; receiving, by the at least one processor, a request to perform at least one second activity using the bound schema-specific identifier; determining, by the at least one processor, if a second entity associated with the request to perform the at least one second activity is associated with the at least one binding category; and performing, by the at least one processor, one of: approving, by the at least one processor, the request to perform the at least one second activity based on a determination that a second entity associated with the at least one second activity is also associated with the at least one binding category; or declining, by the at least one processor, the request to perform the at least one second activity based on a determination that the second entity associated with the at least one second activity is not associated with the at least one binding category.

In some embodiments, the present disclosure provides an exemplary technically improved computer-based system that includes at least the following components of a computing device of a provider server configured to execute software instructions that cause the computing device to at least: generate an unbound schema-specific identifier associated with a user profile of a user; where the user profile is associated with an entity; receive activity data related to at least one first activity performed by the user utilizing the unbound schema-specific identifier; train an entity category determining machine learning engine based on at least one input to obtain a trained entity category determining machine learning engine that is trained to identify at least one category associated with the entity; where the at least one input includes at least one of: at least one entity data feature vector, at least one historical user activity data feature vector associated with the user profile, or at least one historical user schema-specific identifier data feature vector; predict, via the trained entity category determining machine learning engine, at least one predicted category associated with the at least one first activity performed by the user; bind the unbound schema-specific identifier to at least one binding category to generate a category bound schema-specific identifier; where the at least one binding category is based on the at least one predicted category from the trained entity category determining machine learning engine; receive a request to perform at least one second activity using the bound schema-specific identifier; determine if a second entity associated with the request to perform the at least one second activity is associated with the at least one binding category; and perform one of: approving the request to perform the at least one second activity based on a determination that a second entity associated with the at least one second activity is also associated with the at least one binding category; or declining the request to perform the at least one second activity based on a determination that the second entity associated with the at least one second activity is not associated with the at least one binding category.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating an exemplary computer-based system for binding an unbound VCN to at least one merchant category, according to one or more embodiments of the present disclosure.

FIG. 2 is a process flow diagram illustrating an example of a computer-based process for binding an unbound VCN to at least one merchant category, according to one or more embodiments of the present disclosure.

FIG. 3 is a process flow diagram illustrating an example of a computer-based process for binding an unbound VCN to at least one merchant category, according to one or more embodiments of the present disclosure.

FIG. 4 is a block diagram illustrating an exemplary computer-based system and platform, according to one or more embodiments of the present disclosure.

FIG. 5 is a block diagram illustrating another exemplary computer-based system and platform, according to one or more embodiments of the present disclosure.

FIG. 6 is a schematic illustration of an exemplary implementation of a cloud computing/architecture(s) in which the exemplary inventive computer-based system and platform of the present disclosure may be specifically configured to operate, according to one or more embodiments of the present disclosure.

FIG. 7 is another schematic illustration of an exemplary implementation of a cloud computing/architecture(s) in which the exemplary inventive computer-based system and platform of the present disclosure may be specifically configured to operate, according to one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

As used herein, the term “customer”, “client” or “user” shall have a meaning of at least one customer or at least one user respectively.

As used herein, the term “mobile computing device”, “user device” or the like, may refer to any portable electronic device that may include relevant software and hardware. For example, a “mobile computing device” can include, but is not limited to, any electronic computing device that is able to among other things receive and process alerts from a customer or a financial entity including, but not limited to, a mobile phone, smart phone, or any other reasonable mobile electronic device that may or may not be enabled with a software application (App) from the customer's financial entity.

In some embodiments, a “mobile computing device” or “user device” may include computing devices that typically connect using a wireless communications medium such as cell phones, smart phones, tablets, laptops, computers, pagers, radio frequency (RF) devices, infrared (IR) devices, CBs, integrated devices combining one or more of the preceding devices, or virtually any mobile computing device that may use an application, software or functionality to receive and process alerts, credit offers, credit requests, and credit terms from a customer or financial institution.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, various exemplary computer systems of the present disclosure are configured to operate with virtual card numbers (VCNs) that at least some credit card companies may provide customers to combat fraud and/or protect transactions completed by the customer. For example, in at least some embodiments, some credit card companies may give a customer a unique virtual card number (VCN) for every website where the customer shops, which may be referred to as binding the VCN to one or more merchants. In these instances, those bound VCNs cannot be used anywhere else other than the bound merchants. If a merchant site is compromised, there would be no way the VCN can be used to make purchases elsewhere. For example, in at least some embodiments, the VCN cannot be used to access the customer's account data on the card issuer's application or website either. For example, in at least some embodiments, some credit card companies may allow customers to use their credit card accounts to create multiple VCNs, which transact normally and work just like regular credit cards. For example, in at least some embodiments, a customer may be able to control (by binding the VCN) the merchants at which VCNs can be used. For example, in at least some embodiments, a VCN decision system may approve a transaction if the merchant data for the bound merchant matches the merchant data for the merchant where a transaction is being requested (and declines those transactions where the VCN decision system detects the merchants do not match). For example, if a customer creates a VCN that would be bound to Merchant #1 and later that VCN is used to attempt a transaction at Merchant #2, the VCN decision system may decline this transaction. This capability, called “merchant binding,” leads to a substantial reduction in fraud rates. For example, in at least some embodiments, various exemplary computer systems of the present disclosure are configured to operate to address an exemplary technological problem of a misuse and high quantities of VCNs that can be difficult to maintain when merchant-bound VCNs are used for all online spend by a customer.

At least some embodiments of the present disclosure relate to systems and methods for creating a merchant category bound unique schema-specific identifier (i.e., merchant-category VCN) enabled for online and in-store use at a merchant with one or more approved merchant categories. In some embodiments, utilizing at least one machine learning models, including without limitation, self-retraining machine learning models, these disclosed systems and methods may detect at least one merchant category code (MCC) associated with a merchant where the merchant-category VCN is first created and bind it to that category so it can be recalled over and over for use at any merchant within that at least one merchant category code. In some embodiments, the at least one MCC may be used to define a super-category including a plurality of MCCs to which the merchant-category VCN is bound. In some embodiments, an exemplary trained machine learning model may be trained to detect the creation of a VCN and automatically bind it to one or more merchant categories and recall this merchant category bound VCN when shopping at a merchant in the same one or more merchant categories in the future. Thus, the merchant-category VCN may be used for safe checkout online or in-store when shopping at similar types of merchants (apparel, grocery, gas, etc.)

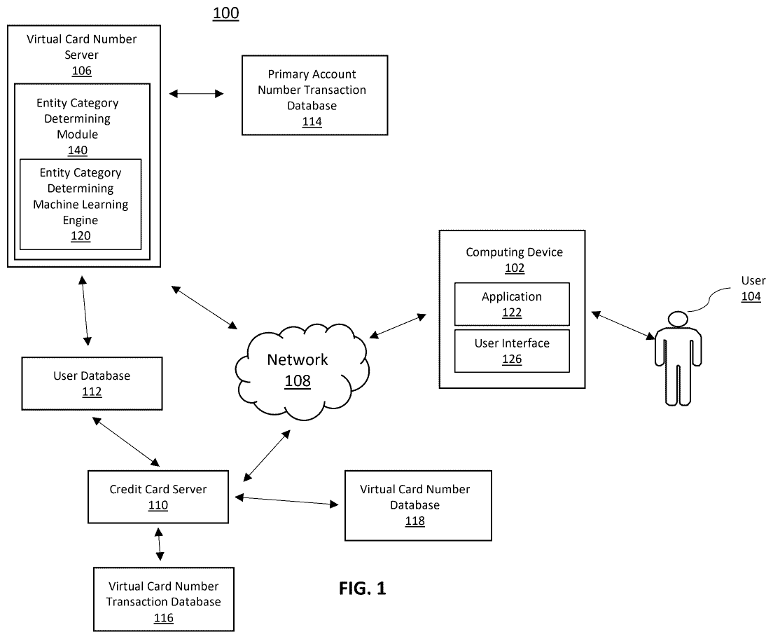

FIGS. 1 through 7 illustrate systems and methods for binding a unique schema-specific identifier (i.e., a VCN) to one or more merchant categories. In some embodiments, a system is configured to recognize at least one merchant category of a merchant associated with a transaction performed using the merchant-category VCN and automatically bind the merchant-category VCN to that at least one merchant category. The following embodiments provide technical solutions and technical improvements that overcome technical problems, drawbacks and/or deficiencies in the technical fields involving the secure generation and implementation of unique schema-specific identifiers (e.g., VCNs) so as to combat fraud and protect user information. As explained in more detail, below, the present disclosure provides technically advantageous computer architecture that improves the security of user payment information when generating unique schema-specific identifiers. In some embodiments, the system and methods are technologically improved by being programmed with machine-learning to identify merchant categories for binding the unique schema-specific identifiers. Based on such technical features, further technical benefits become available to users and operators of these systems and methods. Moreover, various practical applications of the disclosed technology are also described, which provide further practical benefits to users and operators that are also new and useful improvements in the art.

FIG. 1 is a block diagram illustration of an exemplary system 100 used to implement one or more embodiments of the present disclosure. The components and arrangements shown in FIG. 1 are not intended to limit the disclosed embodiments as the components used to implement the disclosed processes and features may vary. In accordance with disclosed implementations, the system 100 may include a virtual card number server 106 in communication with a user computing device 102 associated with a user 104 via a network 108. In some embodiments, the system 100 also includes a credit card server 110 in communication with the computing device 102 and the virtual card number server 106 via the network 108.

Network 108 may be of any suitable type, including individual connections via the internet such as cellular or Wi-Fi networks. In some embodiments, network 108 may connect participating devices using direct connections such as radio-frequency identification (RFID), near-field communication (NFC), Bluetooth™, low-energy Bluetooth™ (BLE), Wi-Fi™, ZigBee™ ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

In some embodiments, virtual card number server 106 may be associated with a first entity. In some embodiments, the first entity may be a financial institution. For example, virtual card number server 106 may manage individual user profiles (e.g., virtual card number accounts) or process transactions.

In some embodiments, the virtual card number server 106 may include one or more logically or physically distinct systems. As further described herein, the virtual card number server 106 may perform operations (or methods, functions, processes, etc.) that may require access to one or more peripherals and/or modules. In the example of FIG. 1, virtual card number server 106 includes an entity category determining module 140.

As seen in FIG. 1, the virtual card number server 106 may include a processor, RAM, ROM, network interface, input/output interfaces (e.g., keyboard, mouse, display, printer, etc.), and memory. In some embodiments, the processor may include one or more computer processing units (CPUs), graphical processing units (GPUs), and/or other processing units such as a processor adapted to perform computations associated with machine learning. In some embodiments, the processor may include any type of data processing capacity, such as a hardware logic circuit, for example, an application specific integrated circuit (ASIC) and a programmable logic, or such as a computing device, for example a microcomputer or microcontroller that includes a programmable microprocessor. In some embodiments, the I/O may include a variety of interface units and drives for reading, writing, displaying, and/or printing data or files. In some embodiments, the I/O may be coupled with a display such as display. In some embodiments, the memory may store software for configuring the virtual card number server into a special purpose computing device in order to perform one or more of the various functions discussed herein. In some embodiments, the memory may store operating system software for controlling overall operation of the virtual card number server 106, control logic for instructing the virtual card number server 106 to perform aspects discussed herein, an entity category determining machine learning engine 120, and other applications. In some embodiments, the entity category determining machine learning engine 120 may include a trained machine learning model/algorithm without departing from this disclosure. In some embodiments, the control logic may be incorporated in and may be a part of the entity category determining machine learning engine 120.

In some embodiments, credit card server 110 may be associated with the first entity. In some embodiments, the credit card server 110 may include one or more logically or physically distinct computer systems. In some embodiments, the credit card server 110 may manage individual profiles and/or process credit card transactions. In some embodiments, the credit card server 110 may provide data to the virtual card number server 106 via the network 108. As further described herein, the credit card server 110 may perform operations (or methods, functions, processes, etc.) that may require access to one or more peripherals and/or modules.

In some embodiments, the credit card server 110 and the virtual card number server 106 may operate in a standalone environment. In some embodiments, the credit card server 110 and the virtual card number server 106 may operate in a networked environment. As depicted in FIG. 1, the credit card server 110 and the virtual card number server 106 may be interconnected as network nodes via the network 108. In some embodiments, other networks may also or alternatively be used, including private intranets, corporate networks, LANs, wireless networks, personal networks, and the like. A local area network (LAN) may have one or more of any known network topologies and may use one or more of a variety of different protocols, such as Ethernet. The credit card server 110 and the virtual card number server 106 may be connected to then network 108 via twisted pair wires, coaxial cable, fiber optics, radio waves or other communication media.

In some embodiments, the computing device 102 may be associated with the user 104. In some embodiments, the computing device 102 may generally include at least computer-readable non-transient medium, a processing component, an Input/Output (I/O) subsystem and wireless circuitry. In some embodiments, these components may be coupled by one or more communication buses or signal lines. In some embodiments, the computing device 102 may include a microprocessor, a memory, a contactless communication interface having a communication field and the display. The computing device 102 may also include means for receiving user input, such as a keypad, touch screen, voice command recognition, a stylus, and other input/output devices, and the display may be any type of display screen, including an LCD or LED display. In some embodiments, the computing device 102 may be, without limitations, a desktop computer, a laptop computer, a tablet, a mobile phone or portable device, or any other computing hardware. In some embodiments, the computing device 102 includes a user interface 126.

In some embodiments, the computing device 102 may be configured to execute software instructions for performing one or more operations consistent with the disclosed embodiments. In some embodiments, the computing device 102 may be a mobile device (e.g. tablet, smartphone, etc.), a desktop computer, a laptop, a server, a wearable device (eyeglasses, a watch, etc.), and/or dedicated hardware device. In some embodiments, the computing device 102 may include one or more processors configured to execute software instructions stored in memory, such as memory included in computing device 102. In some embodiments, the computing device 102 may include software that, when executed by a processor, performs known Internet-related communication and content display processes. For instance, in some embodiments, the computing device 102 may execute browser software that generates and displays interface screens including content on a display device included in, or connected to, the computing device 102. The disclosed embodiments are not limited to any particular configuration of the computing device 102. For instance, the computing device 102 may be a mobile device that stores and executes mobile applications that provide financial-service-related functions offered by a financial service provider, such as an application associated with one or more user profiles that a user holds with a financial service provider.

In some embodiments, the computing device 102 may have data connectivity to a network, such as the Internet, via a wireless communication network, a cellular network, a wide area network, a local area network, a wireless personal area network, a wide body area network, or the like, or any combination thereof. In some embodiments, through this connectivity, the computing device 102 may communicate with the virtual card number server 106.

In some embodiments, the computing device 102 may also communicate, through the network 108, with the virtual card number server (also referred to as a backend server) 106 and/or the credit card server 110. In some embodiments, the virtual card number server 106 and/or the credit card server 110 may be associated with a financial institution.

In some embodiments, the computing device 102 may include an application such as a financial application 122 (or application software) which may include program code (or a set of instructions) that performs various operations (or methods, functions, processes, etc.), as further described herein.

As depicted in FIG. 1, in some embodiments, a user database 112 may be connected to both the credit card server 110 and the virtual card number server 106. In some embodiments, the user database 112 may include various information regarding the user 104. In some embodiments, the user database 112 may include information about the user 104 such as: name, address, date of birth, social security number, primary account number, virtual account numbers, other account information, and any other information about the user 104. As illustrated in FIG. 1, in some embodiments, both the credit card server 110 and/or the virtual card number server 106 may pull the user information from the user database 112.

Additionally, in some embodiments, a primary account number (PAN) transaction database 114 may be connected to the credit card server 110. The PAN transaction database 114, in some embodiments, may include information and data related to previous PAN transactions, such as any of the transactions related to the primary account number for the user 104. In some embodiments, these PAN transactions may include one or more of the following: credit card transactions using the PAN or debit card transactions using the PAN. In some embodiments, other PAN transactions associated with the primary account number may be included in the PAN transaction database 114.

Additionally, in some embodiments, a VCN transaction database 116 may be connected to the virtual card number server 106. In some embodiments, the VCN transaction database 116 may include information and data related to any of the VCN transactions, such as any of the transactions related to VCNs for the user 104. In some embodiments, these VCN transactions may include one or more of the following: unbound VCN transactions or bound VCN transactions using a VCN. In some embodiments, other VCN transactions associated with the virtual card number may be included in the VCN transaction database 116.

In some embodiments, a VCN database 118 may be connected to the virtual card number server 106. In some embodiments, the VCN database 118 may include information and data related to the VCNs, to include both unbound VCNs and bound VCNs. In some embodiments, the VCN database 118 can sort and filter the unbound VCNs and the bound VCNs from various customers.

In some embodiments a user 104 may create an unbound VCN for use within at least one merchant category. In some embodiments, the user 104 can use a VCN just like an actual credit card-just shop online, start the checkout process, and use a VCN to make the purchase. In some embodiments, the VCN may work with any online merchant that accepts credit card payments. In some embodiments, the user's information may be maintained and stored in the customer database 114. In some embodiments, the customer database 114 may include various information regarding the user 104 in the system 100 such as: user name, user address, user date of birth, user social security number, user primary account number, user virtual account numbers, other account information, and any other information about the user. In some embodiments, the unbound VCNs may be maintained and stored in the VCN database 118.

In some embodiments, the user 104 may create an unbound VCN as compared to creating a bound VCN. If an unbound VCN is created, in some embodiments, the user 104 may make at least one purchase, including recurring and non-recurring purchases on a VCN, then not make any purchases at new merchants. During this process, in some embodiments, the user 104 may create multiple VCNs and make other purchases on other VCNs and their physical card (online and in person). When a VCN is created, the user 104 may not know what he/she really wants in reference to binding. In some embodiments, it is simplest for the user 104 to create an unbound VCN. However, in some embodiments, the merchant may facilitate the user 104 creating a bound VCN by providing pre-determined categories, as will be described in further detail below.

Sometimes, the user 104 may start spending using the unbound VCN. If a user can shop online with an actual credit card, the user can probably shop online with a VCN. In some embodiments, the VCN may be linked to the user's credit card account. In some embodiments, VCNs may also require a tool, such as a browser extension, an application or a downloadable program of some kind. In some embodiments, once the user 104 is set up, the user 104 may typically shop online like normal using the VCN. In some embodiments, when it is time to check out, the tool (e.g., browser extension) may generate a VCN for the user 104. In some embodiments, the tool can also store and retrieve VCNs for the next time the user 104 shops. In some embodiments, VCNs may make online shopping easier and more secure. In some embodiments, VCNs may add another layer of protection to the user's credit card account in case a site where a credit card number is stored is ever compromised. In some embodiments, VCNs may give a user extra confidence when making a purchase at a website the user has not used before. In some embodiments, if fraudulent activity or a data leak does happen with the merchant or website, the user's actual card number is protected. Additionally, instead of reentering the actual card number each time the user checks out, in some embodiments, the user can use VCNs to auto-fill payment information to save time.

In some embodiments, if a VCN is being used, the virtual card number server 106 may be configured to execute the entity category determining module 140. In some embodiments, the entity category determining module 140 may be implemented as an application (or set of instructions) or software/hardware combination configured to perform operations for identifying one or more merchant categories to which to bind the VCN.

In some embodiments, the entity category determining machine module 140 may be configured to utilize one or more machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments, the entity category determining machine learning engine 120 may provide data munging, parsing, and machine learning models to help predict the at least one merchant category to which the VCN is to be bound. As was described above, in some embodiments, the entity category determining machine learning engine 120 may utilize one or more of a variety of machine learning architectures known and used in the art. In some embodiments, these architectures can include, but are not limited to, decision trees, k-nearest, neighbors, support vector machines (SVM), neural networks (NN), recurrent neural networks (RNN), convolutional neural networks (CNN), transformers, and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In some embodiments, a combination of machine classifiers can be utilized, more specific machine classifiers when available, and general machine classifiers at other times can be used.

In some embodiments, the entity category determining module 140 includes the entity category determining machine learning engine 120. In some embodiments, the entity category determining machine learning engine 120 may employ the Artificial Intelligence (AI)/machine learning techniques to determine at least one merchant category and/or super category based on the user's purchasing behavior. In some embodiments, the entity category determining machine learning engine 120 may receive and process data from various sources. In some embodiments, the data sources may include user purchasing behavior and other user VCN purchasing behaviors.

In some embodiments, the user purchasing behavior may include one or more of the following inputs, for example: VCN purchases, primary account number (PAN) purchases, etc.

In some embodiments, VCN purchases may include purchase information and transactions for purchases made by the user 104 using a created VCN. In some embodiments, the specific VCN purchase information and transactions may include the merchant, what was purchased, and when it was purchased using the specific VCN. In some embodiments, the VCN purchases may be stored in the VCN transaction database 116. In some embodiments, VCN purchases may also include purchase information and transactions related to the user 104 using other VCNs to make purchases. In some embodiments, this other VCN purchase information and transactions may include the merchant, what was purchased, when it was purchased using other VCNs, etc. In some embodiments, the other VCN purchases may be stored in the VCN transaction database 116.

In some embodiments, the primary account number (PAN) purchases may include purchase information and/or transactions related to the user 104 using his/her primary account number (PAN) for purchases. In some embodiments, this PAN purchase information and/or transactions may include the merchant, what was purchased, and when it was purchased using the PAN card. In some embodiments, the PAN transaction database 114 may include and store the PAN purchase information. In some embodiments, the PAN transaction database 114 may include information and data related to PAN transactions, such as any of the transactions related to the primary account number for the user 104. In some embodiments, these PAN transactions may include one or more of the following: credit card transactions using the PAN or debit card transactions using the PAN. In some embodiments, other PAN transactions associated with the primary account number may be included in the PAN transaction database 114.

In some embodiments, the system 100 may utilize the entity category determining machine learning engine 120 to bind an unbound VCN to one or more merchant categories based on merchant information related to a specific transaction of the unbound VCN. In some embodiments, the entity category determining machine learning engine 120 may receive and process data from various data sources, such as any data source that includes merchant information, merchant categories, etc. In some embodiments, the merchant categories may be based on industry standards, codes, and categories determined by governmental organizations such as, for example, the International Organization for Standardization.

In some embodiments, merchant information may come directly from the merchant. In some embodiments, the merchant information may include the merchant's name, the merchant's category code. In some embodiments, the merchant information may come from the financial institution. For example, in some embodiments, the financial institution may include a merchant database including merchants that have been transacted with by customers. In some embodiments, the merchant database may also include any known information about the merchant based on, for example, transaction histories between customers of the financial institution and the merchant.

In some embodiments, the entity category determining machine learning engine 120 may predict a merchant super category encompassing on several different related MCCs that may be logically grouped together. For example, in some embodiments, the machine learning engine 120 may predict a super category of “travel.” In some embodiments, this category may encompass a group of MCCs related to, for example, airlines, hotels, car rentals, etc.

In some embodiments, the system 100 may utilize the entity category determining machine learning engine 120 to learn and to determine when to bind an unbound VCN based on the merchant information and/or the user's purchasing behavior. In some embodiments, the system 100 may bind the unbound VCN to one or more merchant categories, thereby creating a merchant category bound VCN. In some embodiments, the merchant category bound VCNs may be maintained and stored in the VCN database 118, which may include information and data related to the VCNs, to include both unbound VCNs and merchant category bound VCNs. In some embodiments, the system 100 may automatically bind the unbound VCN to one or more merchant categories based on the Machine learning engine 120 and the user's purchasing behavior. In some embodiments, the system 100 may require either user or financial institution approval prior to binding the unbound VCN to one or more merchant categories.

In some embodiments, the user 104 may request a merchant category bound VCN directly from the financial entity without completing a transaction. For example, in some embodiments, the user 104 may request a merchant category bound VCN via a mobile or computer application provided by the financial institution. In some embodiments, the user 104 may request a VCN via the application and provide inputs as to whether the VCN is to be bound to one or more merchant categories. In some embodiments, the application may provide a list of different merchant categories or super-categories for the user 104 to select from.

In some embodiments, the user 104 may request that the VCN be bound to a group of merchant categories created based on a user-created group. For example, in some embodiments, the user 104 may wish to create a merchant category bound VCN that includes all merchant categories related to hobbies of the user. In these embodiments, the specific hobbies of the user 104 may not be logically grouped together (e.g., sports and food). Thus, the system 100 may not automatically pick these two merchant categories to which to bind a single VCN. Thus, in some embodiments, the user 104 may request a VCN be bound to two or more seemingly uncorrelated merchant categories. In some embodiments, the user 104 may request creation of the VCN via the financial application 122 using the user interface 126. In some embodiments, once the new merchant category bound VCN is issued by the financial institution, the user 104 may only use the merchant category bound VCN at merchants within the selected one or more merchant categories.

In some embodiments, the user 104 may request that a merchant category bound VCN be created for the use of a secondary user. In some embodiments, the user 104 may request creation of the VCN via the financial application 122 using the user interface 126. For example, a parent may wish to create a VCN for the use of a child which can only be used, for example, on food and/or gas. In another example, an employer may request that a merchant category bound VCN be created for use by an employee only within merchant categories related to products or services related to the employer's/employee's business. In some embodiments, the system 100 may create a merchant category bound VCN for the secondary user that is bound to one or more merchant categories specific to the intended use of the VCN.

In some embodiments, after binding the unbound VCN, the system 100 may send a notification to the user 104. In some embodiments, the notification may be real-time or near real-time to the user 104. In some embodiments, the notification may include an email or text or other communication to the user 104 of the binding of the unbound VCN. Additionally, in some embodiments, the user may be able to participate in an “opt out” program for the VCN automatic binding via communications such as email, text, or other mobile communications.

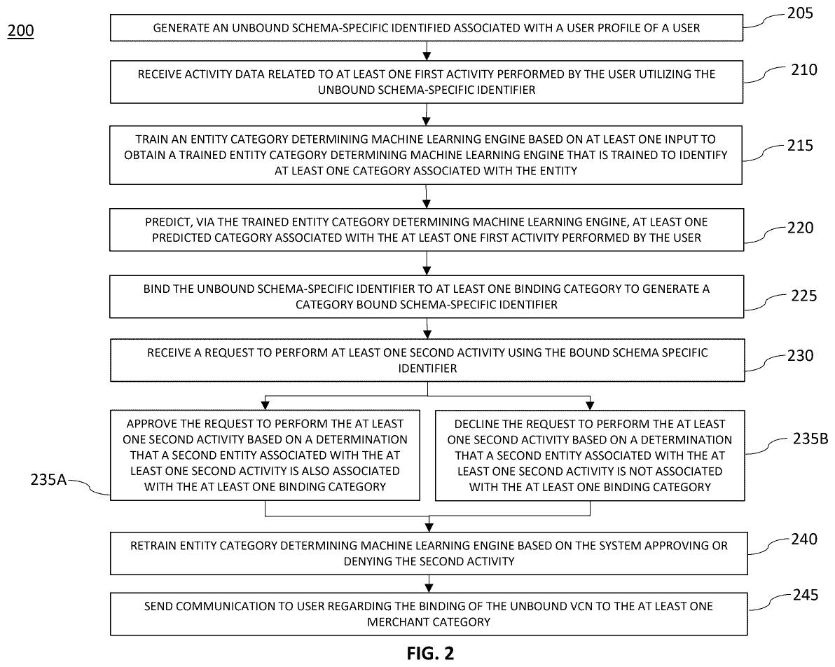

FIG. 2 is a process 200 for binding a virtual card number to one or more merchant categories based on one or more inputs, according to one or more embodiments of the present disclosure. The exemplary computer-mediated process 200 may be executed by software, hardware or a combination thereof. For example, process 200 may be performed by including one or more components described in the system 100 of FIG. 1 (e.g., computing device 102, virtual card number server 106 and credit card server 110). In some embodiments, the process 300 may be implemented in suitable program instructions, such as provided by the system 100, the virtual card number server 106, and the credit card server 110, executing the VCN machine classifier. In some embodiments, some or all of the steps described below may be combined and/or divided into sub-steps as appropriate. It will be readily appreciated that other steps may be included in this method, and that not all steps are necessary in all situations.

At step 205, the system 100 and the virtual card number server 106 may create an unbound VCN associated with a user 104 and a primary account number (PAN) for the user 104. In some embodiments, the unbound VCN may be maintained and stored in the VCN database 118, which may include information and data related to the VCN. In some embodiments, the unbound VCN may be utilized by the user 104 for one or more transactions at one or more unbound merchants. In some embodiments, the user 104 and user information may be stored in a customer database 114 which may include various information regarding the user 104 and other users in the system 100. In some embodiments, the customer database 114 may include information about the user 104 and other users such as: name, address, date of birth, social security number, primary account number, virtual account numbers, other account information, and any other information.

At step 210, the system 100 and the virtual card number server 106 may receive user data such as, for example, a first activity (i.e., transaction) performed by the user 104 utilizing the unbound schema-specific identifier (i.e., VCN). In some embodiments, the user data may include a user purchasing behavior. The user purchasing behavior may include transaction information about the one or more transactions using the unbound VCN. The transaction information may include a merchant name, one or more purchase items, etc. In some embodiments, the virtual card number server 106 may also receive user data including merchant information related to the user purchasing behavior. In some embodiments, the merchant information may include a merchant category code. The user data may also include other user VCN purchasing behaviors that includes transaction information about one or more transactions for other users. The user purchasing behavior may further include one or more additional VCNs created by the user and the transaction information and related merchant information (e.g., MCCs) for the one or more additional VCNs. The VCN transaction information may be stored in the VCN transaction database 116, such as any of the transactions related to the virtual card numbers for the customers.

The customer purchasing behavior may also include the transaction information for one or more primary account number (PAN) transactions using a primary account number (PAN) of the customer. The PAN transactions may be stored in the PAN database and may include information and data related to the PAN transactions, such as any of the transactions related to the primary account number for the customers.

At step 215, the system 100 and the virtual card number server 106 may train a machine learning engine 120 based on at least one input (e.g., user purchasing behavior including historical user transaction data and historical VCN transaction data, merchant information) to predict at least one merchant category or super-category to which to bind the VCN. In some embodiments, tens or hundreds or thousands of data sets may be fed to the entity category determining machine learning engine 120 from the virtual card number server 106 and the various described databases (e.g. PAN transaction database, customer database, VCN transaction database, merchant database). In some embodiments, the entity category determining machine learning engine 120 may be trained such that predictions of one or more merchant categories become increasingly accurate as further data entries are provided to the virtual card number server 106. For example, in some embodiments, the entity category determining machine learning engine 120 may predict a certain merchant category for a merchant associated with one or more VCN transactions based on historical data entries. However, if that merchant is actually associated with a different merchant category or super-category, the entity category determining machine learning engine 120 may be trained on the new data subsets to categorize the merchant differently. In some embodiments, this may be based on user input from customers that the merchant is not within a predicted merchant category. In some embodiments, the machine learning engine 120 may be configured to determine the merchant category or super-category based on at least one of purchase behaviors associated with the unbound VCN, the one or more transactions associated with the VCN, and/or one or more merchants associated with the one or more transactions.

At step 220, the system 100 and the machine learning engine 120 may predict an one or more merchant categories based on a correlation between the user data, particularly one or more categories of merchants within the user data, and the unbound VCN based on the pattern of purchase behaviors. In some embodiments, the correlation between the user data and the unbound VCN may predict that the unbound VCN will not be used at a new category outside of the one or more categories of the unbound merchants for the one or more transactions.

At step 225, the system 100 and the virtual card number server 106 may bind the unbound VCN to one or more merchant categories, creating a bound VCN to merchants within the one or more bound categories. In some embodiments, the VCN is bound based on the correlation between the customer purchasing behavior and the unbound VCN. In some embodiments, the unbound VCN may be bound based on a specific transaction performed by the user 104. In some embodiments, the bound VCNs may be maintained and stored in the VCN database 118, which may include information and data related to the virtual card numbers, to include both unbound virtual card numbers and bound virtual card numbers. In some embodiments, the bound VCN may be utilized for one or more bound transactions in only the one or more bound merchant categories.

At step 230, the system 100 and the virtual card number server 106 may receive a request to perform a new transaction using the bound VCN. In some embodiments, the system 100 and the virtual card number server 106 may request and receive merchant category data for bound transactions utilizing the bound VCN.

At step 235A, the system 100 and the virtual card number server 106 may approve transactions if the merchant data matches the one or more bound merchant categories.

At step 235B, the system 100 and the virtual card number server 106 may decline transactions if the merchant data does not match the one or more bound merchant categories.

At step 240, the entity category determining machine learning engine 120 may be retrained based on the system 100 approving or declining the transaction using the merchant category bound VCN.

At step 245, the system 100 and the virtual card number server 106 may send a communication to the user 104 regarding the binding of the unbound VCN to the at least one merchant category. The communication may be a real-time communication or notification. In some embodiments, the real-time communication or notification may include an email or text or other communication to the customer of the automatic binding of the VCN to one or more merchant categories.

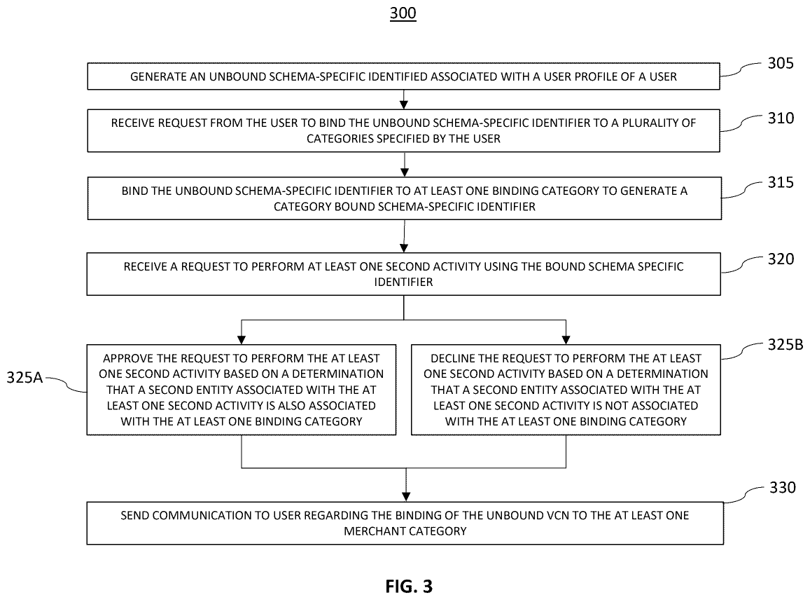

FIG. 3 is a process 300 for binding a virtual card number to one or more merchant categories based on one or more inputs, according to one or more embodiments of the present disclosure. The exemplary computer-mediated process 300 may be executed by software, hardware or a combination thereof. For example, process 300 may be performed by including one or more components described in the system 100 of FIG. 1 (e.g., computing device 102, virtual card number server 106 and credit card server 110). In some embodiments, the process 300 may be implemented in suitable program instructions, such as provided by the system 100, the virtual card number server 106, and the credit card server 110, executing the VCN machine classifier. In some embodiments, some or all of the steps described below may be combined and/or divided into sub-steps as appropriate. It will be readily appreciated that other steps may be included in this method, and that not all steps are necessary in all situations.

At step 305, the system 100 and the virtual card number server 106 may create an unbound VCN associated with a user 104 and a primary account number (PAN) for the user 104. In some embodiments, the unbound VCN may be maintained and stored in the VCN database 118, which may include information and data related to the VCN. In some embodiments, the unbound VCN may be utilized by the user 104 for one or more transactions at one or more unbound merchants. In some embodiments, the user 104 and user information may be stored in a customer database 114 which may include various information regarding the user 104 and other users in the system 100. In some embodiments, the customer database 114 may include information about the user 104 and other users such as: name, address, date of birth, social security number, primary account number, virtual account numbers, other account information, and any other information.

At step 310, the system 100 and the virtual card number server 106 may receive a request from the user 104 to bind the unbound VCN to a plurality of categories specified by the user 104. For example, the user 104 may wish to create a bound VCN that is bound to categories related to a specific user hobby.

At step 315, the system 100 and the virtual card number server 106 may bind the unbound VCN to one or more merchant categories, creating a bound VCN to merchants within the one or more bound categories. In some embodiments, the VCN is bound based on the correlation between the customer purchasing behavior and the unbound VCN. In some embodiments, the unbound VCN may be bound based on a specific transaction performed by the user 104. In some embodiments, the bound VCNs may be maintained and stored in the VCN database 118, which may include information and data related to the virtual card numbers, to include both unbound virtual card numbers and bound virtual card numbers. In some embodiments, the bound VCN may be utilized for one or more bound transactions in only the one or more bound merchant categories.

At step 320, the system 100 and the virtual card number server 106 may receive a request to perform a new transaction using the bound VCN. In some embodiments, the system 100 and the virtual card number server 106 may request and receive merchant category data for bound transactions utilizing the bound VCN.

At step 325A, the system 100 and the virtual card number server 106 may approve transactions if the merchant data matches the one or more bound merchant categories.

At step 325B, the system 100 and the virtual card number server 106 may decline transactions if the merchant data does not match the one or more bound merchant categories.

At step 330, the system 100 and the virtual card number server 106 may send a communication to the user 104 regarding the binding of the unbound VCN to the bound VCN. The communication may be a real-time communication or notification. In some embodiments, the real-time communication or notification may include an email or text or other communication to the customer of the automatic binding of the VCN to one or more merchant categories.

In some embodiments, the system 100 and the virtual card number server 106 may provide the unbound/bound VCN transaction information to an illustrative fraud system or at least one illustrative fraud algorithm/model. In some embodiments, the fraud system or fraud algorithm/model may be configured to determine how a specific number or VCN was compromised. VCNs also can help limit how much information may be accessible to fraudsters if customer information is stolen in a phishing scam or a data breach. For example, when VCNs show up fraudulent at a merchant, the binding of the virtual card number by the system 100 and the virtual card number server 106 will help feed the fraud system or fraud algorithm and help with fraud prevention.

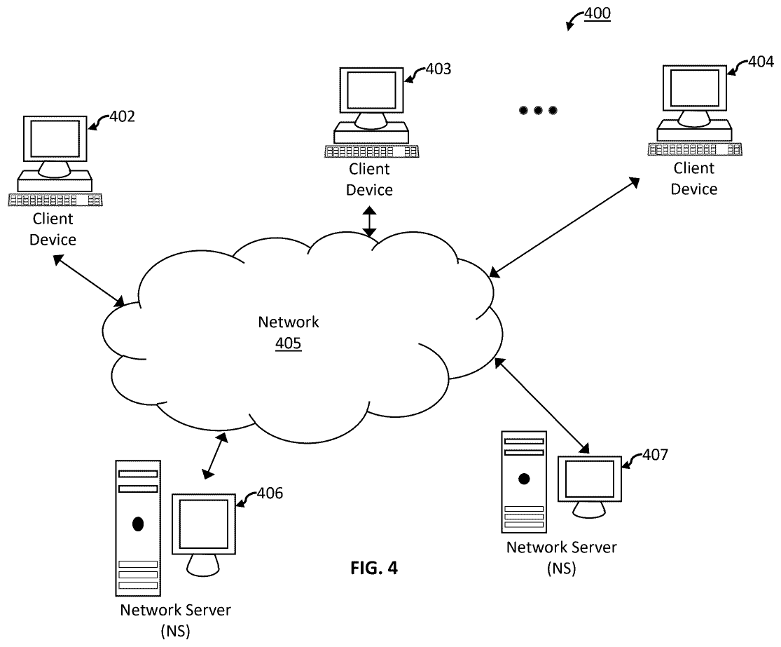

FIG. 4 depicts a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, member computing device 402, member computing device 403 through member computing device 404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more member devices within member devices 402-404 may include may run one or more applications, such as Internet browsers, mobile applications, voice calls, video games, videoconferencing, and email, among others. In some embodiments, one or more member devices within member devices 402-804 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Apache on Linux or Microsoft IIS (Internet Information Services). In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

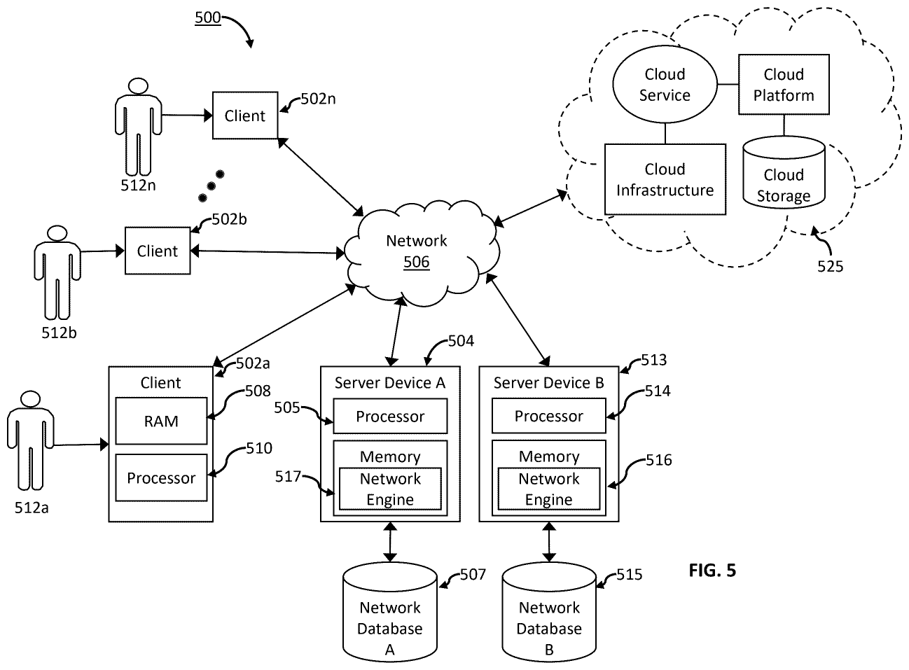

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 502a, member computing device 502b through member computing device 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, user 512a, user 512b through user 512n, may communicate over the exemplary network 506 with each other and/or with other systems and/or devices coupled to the network 506. As shown in FIG. 5, exemplary server devices 504 and 513 may include processor 505 and processor 514, respectively, as well as memory 517 and memory 516, respectively. In some embodiments, the server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

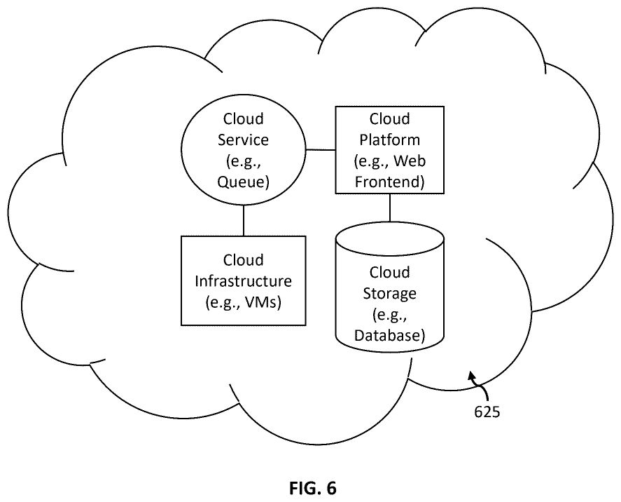

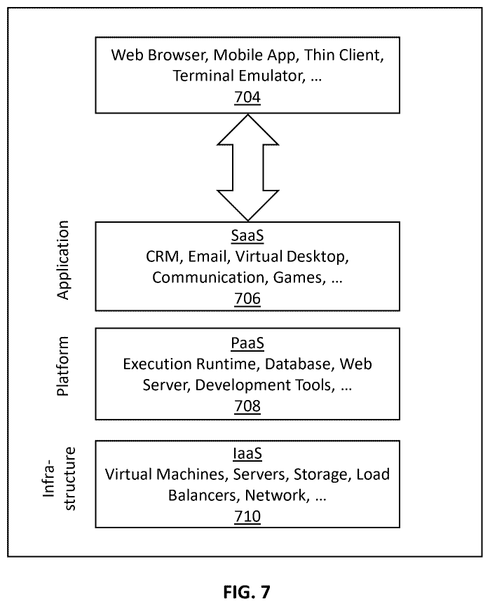

In some embodiments, the exemplary inventive computer-based systems/platforms, the exemplary inventive computer-based devices, and/or the exemplary inventive computer-based components of the present disclosure may be specifically configured to operate in a cloud computing/architecture 525 or 625 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) Open VMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

1. A computer-implemented method, the method including:
generating, by at least one processor, an unbound schema-specific identifier associated with a user profile of a user;
   where the user profile is associated with an entity;
receiving, by the at least one processor, activity data related to at least one first activity performed by the user utilizing the unbound schema-specific identifier;
training, by at least one processor, an entity category determining machine learning engine based on at least one input to obtain a trained entity category determining machine learning engine that is trained to identify at least one category associated with the entity;
   where the at least one input includes at least one of:
      at least one entity data feature vector,
      at least one historical user activity data feature vector associated with the user profile, or
      at least one historical user schema-specific identifier data feature vector;
predicting, by the at least one processor, via the trained entity category determining machine learning engine, at least one predicted category associated with the at least one first activity performed by the user;
binding, by the at least one processor, the unbound schema-specific identifier to at least one binding category to generate a category bound schema-specific identifier;
   where the at least one binding category is based on the at least one predicted category from the trained entity category determining machine learning engine;
receiving, by the at least one processor, a request to perform at least one second activity using the bound schema-specific identifier;
determining, by the at least one processor, if a second entity associated with the request to perform the at least one second activity is associated with the at least one binding category; and
performing, by the at least one processor, one of:
   approving, by the at least one processor, the request to perform the at least one second activity based on a determination that a second entity associated with the at least one second activity is also associated with the at least one binding category; or
   declining, by the at least one processor, the request to perform the at least one second activity based on a determination that the second entity associated with the at least one second activity is not associated with the at least one binding category.

2. The method of clause 1, further including: retraining, by the at least one processor, based on at least one of the approving the request to perform one or more second activities or the declining the request to perform the at least one second activity, the trained entity category determining machine learning engine.

3. The method of clause 1, further including: retraining, by the at least one processor, based on at least one user input that the second entity is not associated with the bound category, the trained entity category determining machine learning engine.

4. The method of clause 1, where at least one historical user schema-specific identifier data feature vector includes one or more second schema-specific identifiers created by the user.

5. The method of clause 4, where the schema-specific identifier further includes transaction information for the one or more second schema-specific identifiers.

6. The method of clause 1, where the at least one historical user activity data feature vector associated with the user profile includes transaction information for one or more primary account number (PAN) transactions using a primary account number (PAN) of the user.

7. The method of clause 1, further including: generating, by the at least one processor, a real-time communication to the user regarding the binding of the unbound schema-specific identifier to the at least one binding category.

8. The method of clause 1, where the least one input further includes a plurality of second user activities that include a plurality of second user activity information about the plurality of second user activities.

9. The method of clause 1, further including: requesting and receiving, by the at least one processor, entity data for the at least one second activity utilizing the bound schema-specific identifier.

10. The method of clause 1, further including: providing, by the at least one processor, data related to the at least one second activity using the bound schema-specific to a fraud algorithm to determine fraudulent activity.

11. A system including:
a computing device of a provider server configured to execute software instructions that cause the computing device to at least:
   generate an unbound schema-specific identifier associated with a user profile of a user;
      where the user profile is associated with an entity;
   receive activity data related to at least one first activity performed by the user utilizing the unbound schema-specific identifier;
   train an entity category determining machine learning engine based on at least one input to obtain a trained entity category determining machine learning engine that is trained to identify at least one category associated with the entity;
      where the at least one input includes at least one of:
         at least one entity data feature vector,
         at least one historical user activity data feature vector associated with the user profile, or
         at least one historical user schema-specific identifier data feature vector;
   predict, via the trained entity category determining machine learning engine, at least one predicted category associated with the at least one first activity performed by the user;
   bind the unbound schema-specific identifier to at least one binding category to generate a category bound schema-specific identifier;
      where the at least one binding category is based on the at least one predicted category from the trained entity category determining machine learning engine;
   receive a request to perform at least one second activity using the bound schema-specific identifier;
   determine if a second entity associated with the request to perform the at least one second activity is associated with the at least one binding category; and
   perform one of:
      approving the request to perform the at least one second activity based on a determination that a second entity associated with the at least one second activity is also associated with the at least one binding category; or
      declining the request to perform the at least one second activity based on a determination that the second entity associated with the at least one second activity is not associated with the at least one binding category.

12. The system of clause 11, where the software instructions, when executed, further cause the computing device to perform steps to: retrain, based on at least one of the approving the request to perform the at least one second activity or the declining the request to perform the at least one second activity, the trained entity category determining machine learning engine.

13. The system of clause 11, where the software instructions, when executed, further cause the computing device to perform steps to: retrain, based on at least one user input that the second entity is not associated with the bound category, the trained entity category determining machine learning engine.

14. The system of clause 11, where at least one historical user schema-specific identifier data feature vector includes one or more second schema-specific identifiers created by the user.

15. The system of clause 14, where the schema-specific identifier further includes transaction information for the one or more second schema-specific identifiers.

16. The system of clause 11, where the at least one historical user activity data feature vector associated with the user profile includes transaction information for one or more primary account number (PAN) transactions using a primary account number (PAN) of the user.

17. The system of clause 11, where the software instructions, when executed, further cause the computing device to perform steps to: generate a real-time communication to the user regarding the binding of the unbound schema-specific identifier to the at least one binding category.

18. The system of clause 11, where the least one input further includes a plurality of second user activities that include a plurality of second user activity information about the plurality of second user activities.

19. The system of clause 11, where the software instructions, when executed, further cause the computing device to perform steps to: request and receive entity data for the at least one second activity utilizing the bound schema-specific identifier.

20. The system of clause 11, where the software instructions, when executed, further cause the computing device to perform steps to: provide data related to the at least one second activity using the bound schema-specific to a fraud algorithm to determine fraudulent activity.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A computer-implemented method, the method comprising:
receiving, by at least one processor, activity data related to at least one first activity performed by a user utilizing an unbound schema-specific identifier;
predicting, by the at least one processor, via an entity category determining machine learning engine, at least one category associated with the at least one first activity performed by the user, wherein the entity category determining machine learning engine is trained to associate categories with entities based on at least one of:
at least one entity data feature vector,
at least one historical user activity data feature vector, and
at least one historical user schema-specific identifier data feature vector;
binding, by the at least one processor, the unbound schema-specific identifier to the predicted at least one category to generate a category bound schema-specific identifier; and
instructing, by the at least one processor, at least one second activity based on the category bound schema-specific identifier.

2. The method of claim 1, wherein the unbound schema-specific identifier is associated with a user profile of the user, the user profile being associated with an entity.

3. The method of claim 2, wherein the at least one historical user activity data feature vector associated with the user profile comprises transaction information for one or more primary account number (PAN) transactions using a primary account number (PAN) of the user.

4. The method of claim 1, wherein instructing the at least one second activity comprises:
approving, by the at least one processor, a request to perform the at least one second activity based on a determination that a second entity associated with the at least one second activity is also associated with the at least one category, or
declining, by the at least one processor, the request to perform the at least one second activity based on a determination that the second entity associated with the at least one second activity is not associated with the at least one category.

5. The method of claim 4, further comprising:
retraining, by the at least one processor, based on approving or declining the request to perform the at least one second activity, the entity category determining machine learning engine.

6. The method of claim 1, further comprising:
retraining, by the at least one processor, based on at least one user input that a second entity associated with the at least one second activity is not associated with the at least one category, the entity category determining machine learning engine.

7. The method of claim 1, wherein
at least one historical user schema-specific identifier data feature vector comprises one or more second schema-specific identifiers created by the user.

8. The method of claim 7, wherein the schema-specific identifier further comprises transaction information for the one or more second schema-specific identifiers.

9. The method of claim 1, further comprising:
generating, by the at least one processor, a real-time communication to the user regarding the binding of the unbound schema-specific identifier to the at least one category.

10. The method of claim 1, further comprising:
requesting and receiving, by the at least one processor, entity data for the at least one second activity utilizing the bound schema-specific identifier.

11. The method of claim 1, further comprising:
providing, by the at least one processor, data related to the at least one second activity using the bound schema-specific identifier to a fraud algorithm to determine fraudulent activity.

12. A system comprising:
a computing device of a provider server configured to execute software instructions that cause the computing device to at least:
receive activity data related to at least one first activity performed by a user utilizing an unbound schema-specific identifier;
predict, via an entity category determining machine learning engine, at least one category associated with the at least one first activity performed by the user, wherein the entity category determining machine learning engine is trained to associate categories with entities based on at least one of:
at least one entity data feature vector,
at least one historical user activity data feature vector, and
at least one historical user schema-specific identifier data feature vector;
bind the unbound schema-specific identifier to at least one category to generate a category bound schema-specific identifier; and
instruct at least one second activity based on the category bound schema-specific identifier.

13. The system of claim 12, wherein instructing the at least one second activity comprises:
approving a request to perform the at least one second activity based on a determination that a second entity associated with the at least one second activity is also associated with the at least one category, or
declining the request to perform the at least one second activity based on a determination that the second entity associated with the at least one second activity is not associated with the at least one category.

14. The system of claim 13, wherein the software instructions, when executed, further cause the computing device to perform steps to:
retrain, based on approving or declining the request to perform the at least one second activity, the entity category determining machine learning engine.

15. The system of claim 12, wherein the software instructions, when executed, further cause the computing device to perform steps to:
retrain, based on at least one user input that a second entity associated with the at least one second activity is not associated with the at least one category, the entity category determining machine learning engine.

16. The system of claim 12, wherein at least one historical user schema-specific identifier data feature vector comprises one or more second schema-specific identifiers created by the user.

17. The system of claim 16, wherein the schema-specific identifier further comprises transaction information for the one or more second schema-specific identifiers.

18. The system of claim 12, wherein the software instructions, when executed, further cause the computing device to perform steps to:
generate a real-time communication to the user regarding the binding of the unbound schema-specific identifier to the at least one category.

19. The system of claim 12, wherein the software instructions, when executed, further cause the computing device to perform steps to:
request and receive entity data for the at least one second activity utilizing the bound schema-specific identifier.

20. The system of claim 12, wherein the software instructions, when executed, further cause the computing device to perform steps to:
provide data related to the at least one second activity using the bound schema-specific to a fraud algorithm to determine fraudulent activity.
